(19) United States
(12) Patent Application Publication
(10) Pub. No.: US 2011/0114686 A1
(43) Pub. Date: May 19, 2011

(54) VEHICLE SEAT MOUNTING FOR AN OBJECT EG COMPUTER

(75) Inventor: Brett Justin Eric Franzi, New South Wales (AU)

(73) Assignee: INDUSTRIAL EVOLUTION DESIGN PTY LTD, New South Wales (AU)

(21) Appl. No.: 13/009,455

(22) Filed: Jan. 19, 2011

Related U.S. Application Data
(63) Continuation of application No. 10/580,084, filed on Feb. 28, 2007, now abandoned.

(30) Foreign Application Priority Data
Nov. 19, 2003 (AU) 2003100947
Feb. 26, 2004 (AU) 2004100280

(51) Int. Cl. B60R 7/00

(52) U.S. Cl. 224/275

(57) ABSTRACT

A device (10) for mounting and supporting a load on a seat (12) having a co-operating seat belt, the device (10) comprising a base (14) supported on a seat base; a rear portion (22) for engaging with a seat back; a forward portion (18) for engaging with a seat belt designed as a lap restraint; and means for mounting and retaining a load supported by the base (14), the rear portion (22) having first (20) and second (22) retaining elements, each extending generally at a substantial angle to the base (14) and configured to engage the surfaces of the seat to resist forward movement of the device (10) relative to the seat, irrespective of correct and effective engagement of the seat belt.

### RELATED APPLICATIONS

This application is a continuation of U.S. application Ser. No. 10/580,084 filed Feb. 28, 2007.

### FIELD OF THE INVENTION

The present invention relates generally to a device for mounting an object to a passenger seat of a motor vehicle and has particular application to securing the object to the passenger seat both in normal usage and in the event of any emergency situation such as rapid braking or indeed an accident involving impact.

### BACKGROUND OF THE INVENTION

Existing devices for mounting objects to a seat of a motor vehicle (such as a baby capsule and child car seat) are generally anchored into position using standard seat belt arrangements. Furthermore, the existing devices are for specific types of objects (for example, a baby) and depend on full insertion and latching of the seat belt arrangement. This can be a cumbersome task and there is a danger it may be imperfectly formed.

The existing devices also do not offer a general solution to a device for mounting and supporting an object when perhaps only a lap restraint belt is available and/or an object is desired to be mounted on a passenger seat adjacent a vehicle driver such as a courier.

### SUMMARY OF THE INVENTION

According to a first aspect of the present invention, there is provided a device for mounting and supporting a load on a seat having a co-operating seat belt, the device comprising:

a base to be supported on a seat base;

a rear portion for engaging with a seat back;

a forward portion for engaging with a seat belt designed as a lap restraint; and

means for mounting and retaining, during normal travel, a load supported on the base, the device being such that the rear portion having first and second retaining elements each extending generally a substantial angle to the base and configured to engage with surfaces of the seat structure extending generally at a substantial angle to the seat base such that secure engagement is achieved to resist forward motion of the device relative to the seat, irrespective of whether there is correct and effective engagement of the seat belt.

Preferably, the rear portion of generally T-shaped form with the first and second retaining elements extending respectively upwardly and downwardly as rear projecting walls to engage respectively the rear of a back rest and the rear of the seat, other embodiments may be preferred as advantageous.

Preferably, the first and second retaining elements are spaced from one another by an amount corresponding to the thickness of a back rest and extend upwardly from the base and are configured to engage under a lower portion of the back rest to retain the device in position.

Preferably, the device is in the form of a moulded base having integral upstanding rear walls spaced from one another to form a U-shaped cross sectional shape to be engaged under the rear of a seat back. This is especially advantageous when the seat back is in the form of a resilient cushion and the installation is achieved by the base being lowered at a steep angle to engage the walls respectively around the lower portion of the back cushion and then to pivot the device downwardly to lay the base down to be supported on the seat base.

This arrangement lends itself to specially advantageous industrial designs such as those produced by moulding in one piece with smooth profiles over the whole structure.

Preferably, the base has a substantially flat body portion and an upwardly extending front portion having a forward edge recess for accommodating and retaining a lap seat belt. One embodiment can have a smoothly curved nose having a grooved profile for retaining a lap belt with upper and lower edges for restraining seat belt movement upwardly or downwardly.

Preferably, the device comprises an arrangement on the front portion for swivel mounting of an appliance such as a hand held computer and to provide a quick release system for clamping such a computer into position and removing it as may be required.

Preferably, the device comprises a receiving tray on the base portion between the means for mounting and a seat back for documents to be retained in position.

Such a device can readily be constructed and, subject to traffic regulations, even used while the driver is controlling a moving vehicle. The computer could for example be driven by a navigation system providing navigation information visually and/or through audio communications as well as provide other functions.

Most importantly however, devices according to the present invention can be safely and easily installed in most vehicles and lend themselves to being removed and changed from vehicle to vehicle according to the user's needs. Reliable location with secure engagement with a cushioned conventional seat back can be achieved without damage to the vehicle and at least preferred embodiments can minimise the chance of the device becoming a projectile even if the seat belt is not perfectly engaged.

According to a second aspect of the present invention, there is provided a device for mounting an object to a passenger seat of a motor vehicle, the device comprises:

a support for supporting the object on the passenger seat; and

a securing means for securing the support to the passenger seat, the securing means comprises a belt retainer for retaining a lap restrain belt associated with the passenger seat, the securing means also comprises a seat engaging component for engaging a rear surface of the passenger seat and engaging an end of a back support part of the passenger seat.

An advantage of the device according to the second aspect of the present invention is that by engaging the rear of the passenger seat, the device has additional resistance to movement relative to the seat. The resistance provided by engaging the rear of the seat is in addition to resistance that is provided by the belt retainer when retaining the lap restraint belt. Engaging the end of the back support part of the passenger seat provides resistance against tilting of the device which may otherwise occur under sudden braking.

Preferably, the seat engaging component comprises a first part for engaging the end of the back support and a second part, which extends outwardly from the first part, for engaging the rear surface of the passenger seat.

Preferably, the seat engaging component comprises a third part that extends outwardly from the first part and which is spaced apart from the second part to define a void for receiving the end of the back support part of the passenger seat.

Preferably, the belt retainer comprises spaced apart elements that extend outwardly from a surface of the securing means to define a recess for receiving the lap restrain belt.

Preferably, the securing means comprises a base having opposed end sections, wherein the belt retainer is located at one of the ends and the seat engaging component is located at another of the ends.

Preferably, the support is pivotally coupled to the securing means.

Preferably, the device further comprising a housing mounted to the base for housing the object.

### BRIEF DESCRIPTION OF THE DRAWINGS

For illustrative purposes an embodiment of the present invention will now be described with reference to the accompanying drawings, in which:

FIG. 1 shows a perspective view from the front of a device that embodies the present invention;

FIG. 2 shows the device of FIG. 1 with an optional swivel mount installed for a hand held computer bracket;

FIG. 3 is an underneath view of the device shown in FIG. 1;

FIG. 4 is a rear view of the device shown in FIG. 1;

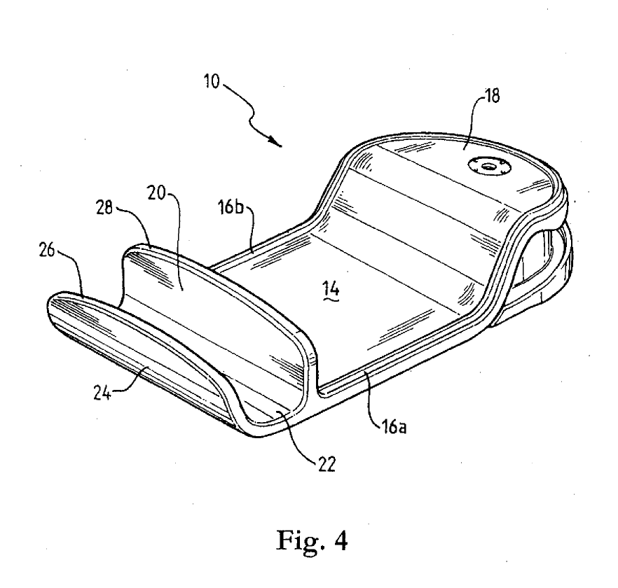

FIG. 5 shows the device of FIG. 1 fitted to a passenger seat of a vehicle;

FIG. 6 is an illustration of another embodiment of the device of FIG. 1, which has a T-shaped end structure;

FIG. 7 illustrates a computing device cradle mounted to the device shown in FIG. 1; and

FIG. 8 shows yet a further embodiment of the device shown in FIG. 1.

### AN EMBODIMENT OF THE INVENTION

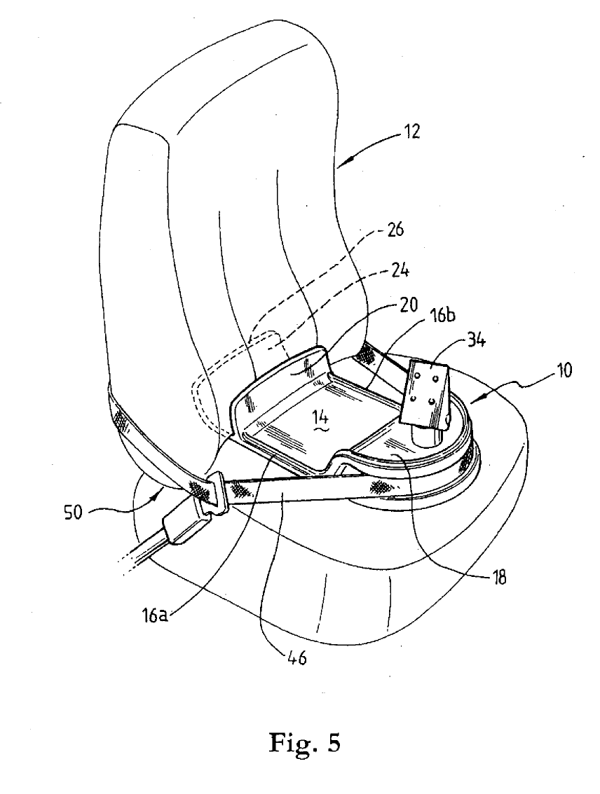

FIG. 5 shows an embodiment of a device 10 for mounting an object to a passenger seat 12 of a motor vehicle. The device 10 has particular application to mounting objects such as computer terminals to the passenger seat 12. However, persons skilled in the art will readily appreciate that other embodiments of the device 10 can be used for mounting other objects to the passenger seat 12 and not just computer terminals. The device 10 is made using a one piece moulding technique from a plastic material with smoothly curved profiles so as to be readily fitted onto the passenger seat 12.

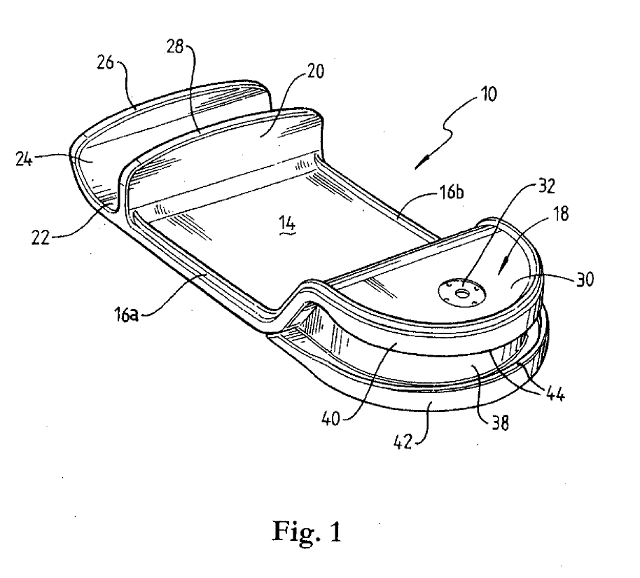

With reference to FIG. 1, the device 10 has a flat base 14 with upper parallel side rails 16 that define a load carrying zone suitable for a file, a book or paperwork. The base 14 has a curved front nose 18, a rear wall 20, and a rearwardly projecting interconnecting wall 22 leading to an upwardly curved back wall 24. The walls 20 and 24 each have rounded corners and curved top edges 26 and 28 respectively.

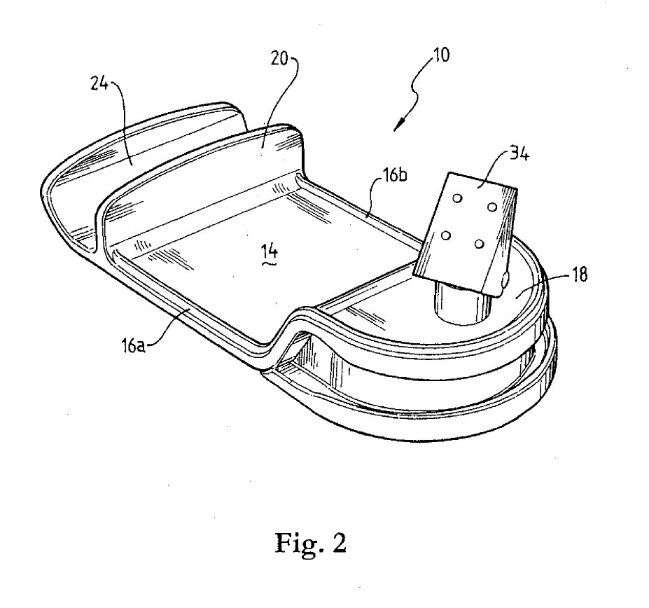

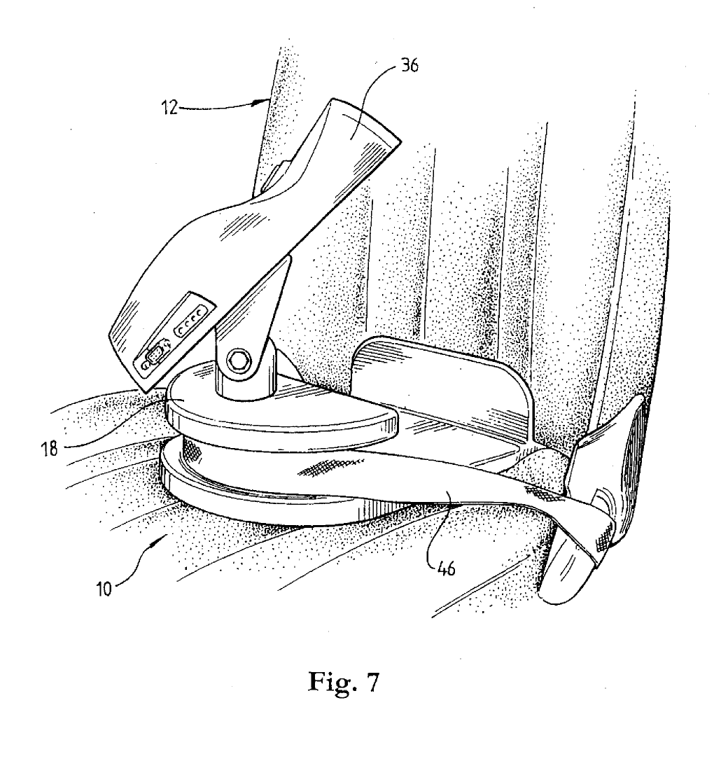

The front nose 18 has a raised platform 30 having a mounting recess 32 for an accessory mounting bracket 34 such as the swivel bracket, which can be seen in FIG. 2. The swivel bracket 34 can mount a quick release cradle 36 (see FIG. 7) for an accessory such as a hand held computer. The front nose 18 also includes a curved skirt 38 extending between upper and lower collars 40 and 42, each of which are spaced radially outwardly from the skirt 38 and have respective flanges 44 which extend partially over the skirt 38 to define a receiving groove having retention lips for accommodating and retaining a lap element 46 (see FIG. 7) of a conventional seat belt.

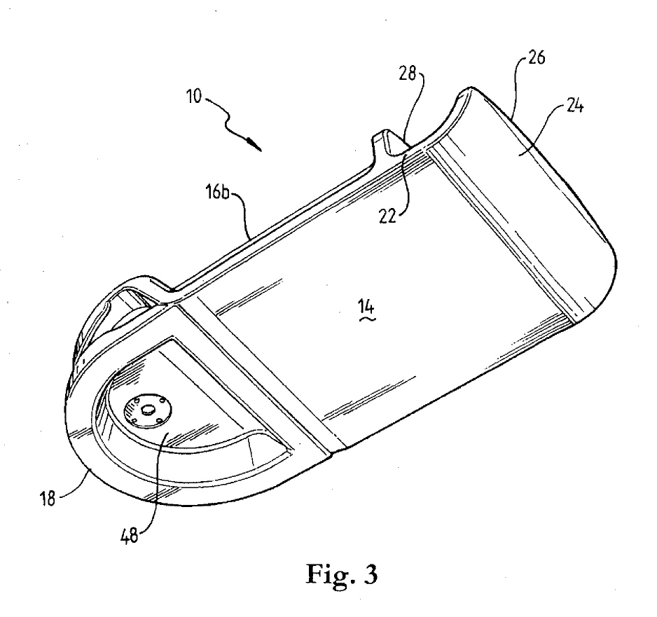

As shown in FIG. 3, to provide lightness and facilitate moulding of the device 10, a cavity 48 extends into the nose potion 18.

As described previously, an accessory-receiving cradle 36 is mounted to the pivotal bracket 34 and installation into a vehicle to obtain the arrangement shown in FIG. 5 is quickly and easily accomplished. The profile of the back wall 24 with its curved upper edge 26 is designed to facilitate being inserted below and behind the bottom edge 50 of the seat 12 back cushion (see FIG. 5). The device 10 is offered up at a steep angle of the base 14 to the seat 12 back cushion, the wall 24 is slid under the bottom of the seat 12 back cushion and the device 10 rotated downwardly to achieve the insertion with the seat 12 back cushion then located between the walls 20 and 24. This can be effected with the accessory bracket 34 or the cradle 36.

It is intended that the lap element 46 then be secured around the nose 18 and the attachment fastened. The design, however, resists forward projection of the device 10 in the event of an accident even if the lap belt 46 is not correctly located, tensioned or closed.

A typical application of the device 10 is for fitting and moving between vehicles such as courier vehicles but the device 10 in the form shown may be used in other installations of a similar character. Furthermore the formation of the device 10 can be altered.

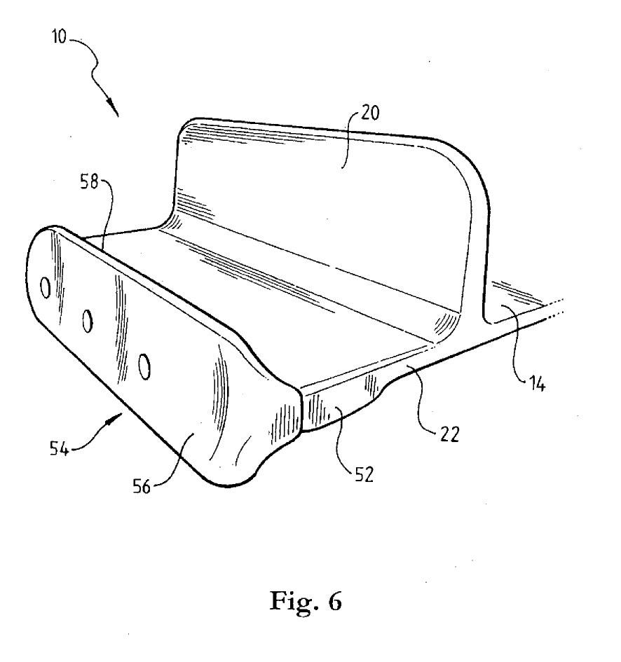

Referring now to FIG. 6, a representation is provided of an alternative embodiment of the device 10 in which a generally T-shaped end structure is formed. In this embodiment the rearwardly extending interconnection wall 22 is planar and is dimensioned to have a width equivalent to the seat 12 back cushion but has a thickened rearwardly extending integral wedge-shaped portion 52 to leave a rearwardly facing back wall onto which is screwed a rear strip 54. The strip 54 has a curved rear wall 56 and a front wall 58 which is essentially parallel to the wall 20.

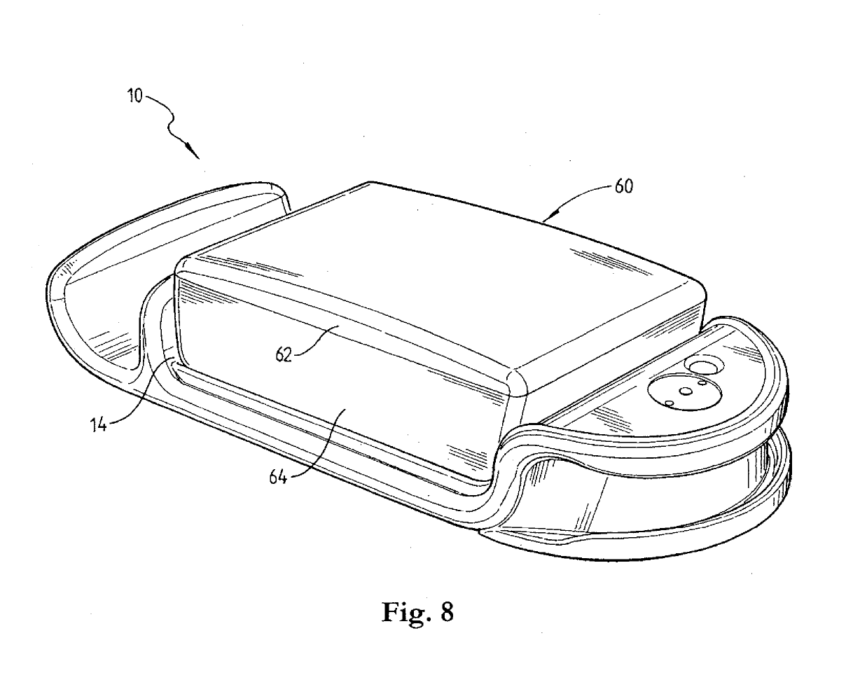

In yet a further embodiment of the device 10, which is shown in FIG. 8, the device 10 comprises a housing 60 that is attached to the base 14 of the device 10. The housing provides a means for storing a computing device (which is mounted to the device 10) when not in use or any other type of objects such as a file. This is advantageous as it allows the computing device or other objects to be stored out of sight when, for example, the vehicle is parked in a street. The housing comprises a lid 62 that is hingedly connected to a body portion 64 of the housing. The lid 62 can be opened and closed to show the object therein.

In summary, embodiments of the invention can be formed in a light-weight, inexpensive and very portable form which can nevertheless be easily and reliably installed into conventional vehicle seats without risk of damage to upholstery. Embodiments can be smoothly curved and styled and produced in robust moulded plastics materials with the ability to be fitted with a wide range of support cradles for different objects such as different hand held computers.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

What is claimed is:

1. A device for mounting and supporting a load on a seat having a co-operating seat belt, the device comprising:
a base to be supported on a seat base;
a rear portion for engaging with a seat back;
a forward portion having a slot arranged to engage with a seat belt designed as a lap restraint;
a mounting portion arranged to mount or retain a load supported on the base; and
the rear portion having a slot member disposed between a first retaining element and a second retaining element, wherein the slot member is utilizable to engage the seat back in use by inserting the first retaining element into an opening disposed between the seat back and the seat base and pivoting the rear portion against the seat back on the slot member such that secure engagement is achieved to resist motion of the device relative to the seat, irrespective of whether there is correct and effective engagement of the seat belt.

2. The device as claimed in claim 1, wherein the rear portion is of generally T-shaped form with the first and second retaining elements extending respectively upwardly and downwardly as rear projecting walls to engage respectively the rear of a back rest and the rear of the seat.

3. The device as claimed in claim 1, wherein the first and second retaining elements are spaced from one another by an amount corresponding to the thickness of a back rest and extend upwardly from the base and are configured to engage under a lower portion of the back rest to retain the device in position.

4. The device as claimed in claim 3, wherein the device is in the form of a moulded base having integral upstanding rear walls spaced from one another to form a U-shaped cross sectional shape to be engaged under the rear of a seat back.

5. The device as claimed in claim 1, wherein the base has a substantially flat body portion and an upwardly extending portion having a forward edge recess for accommodating and retaining a lap seat belt.

6. The device as claimed in claim 5, comprising an arrangement on the forward portion for swivel mounting of an appliance and to provide a release system for removably clamping the appliance into position.

7. The device as claimed in claim 1, comprising a receiving tray on the base portion between the mounting portion for mounting and a seat back for documents to be retained in position.

8. A device for mounting an object to a passenger seat of a motor vehicle, the device comprises:
a support for supporting the object on the passenger seat; and
a securing means for securing the support to the passenger seat, the securing means comprises a belt retainer for retaining a lap restrain belt associated with the passenger seat, the securing means also comprises a seat engaging component including a slot member disposed between a first retaining element and a second retaining element for engaging a rear surface of the passenger seat and engaging an end of a back support part of the passenger seat in use by allowing the first retaining element to be inserted into an opening disposed between the seat back and the seat base and pivoting the rear portion against the seat back on the slot member to engage the seat back into the slot member.

9. The device as claimed in claim 8, wherein the seat engaging component comprises a first part for engaging the end of the back support and a second part, which extends outwardly from the first part, for engaging the rear surface of the passenger seat.

10. The device as claimed in claim 9, wherein the seat engaging component comprises a third part that extends outwardly from the first part and which is spaced apart from the second part to define a void for receiving the end of the back support part of the passenger seat.

11. The device as claimed in claim 8, wherein the belt retainer comprises spaced apart elements that extend outwardly from a surface of the securing means to define a recess for receiving the lap restrain belt.

12. The device as claimed in claim 8, wherein the securing means comprises a base having opposed end sections, wherein the belt retainer is located at one of the ends and the seat engaging component is located at another of the ends.

13. The device as claimed in claim 8, wherein the support is pivotally coupled to the securing means.

14. The device as claimed in claim 8, further comprising a housing mounted to the support for housing the object.
